(19) United States
(12) Patent Application Publication
(10) Pub. No.: US 2006/0109205 A1
(43) Pub. Date: May 25, 2006

(54) High Efficiency multi-mode charge pump based LED driver

(76) Inventor: Qi Deng, Chandler, CA (US)

Correspondence Address: Qi Deng, Apt# 140, 1400 N. Alma School Rd., Chandler, AZ, 85224, US

(21) Appl. No.: 10/997,269

(22) Filed: Nov. 24, 2004

(51) Int. Cl. G09G 3/14

(52) U.S. Cl. 345/46

(57) ABSTRACT

A high efficiency multi-mode charge pump based LED driver comprising a multi-mode charge pump and a LED driver controls the brightness level of at least one group of a plurality of LEDs, which is used as a backlight for a display device. The charge pump provides an output voltage to the plurality of LEDs. It includes at least three modes of operation, and allows automatic switching among modes. Mode selection and automatic mode switching determination are achieved by comparing derived voltages from input voltage and output voltage of the charge pump with an internal reference voltage. The LED driver provides regulated and well matched forward currents to the plurality of LEDs to adjust their brightness levels and ensure the backlight uniformity. The forward current for each LED is generated by amplifying the voltage differential of a voltage derived from an external control input, and a voltage derived from an internal current source.

### CROSS-REFERENCE TO RELATED APPLICATIONS

Not Applicable

### FEDERALLY SPONSORED RESEARCH OR DEVELOPMENT

Not Applicable

### SEQUENCE LISTING OR COMPUTER PROGRAM

Not Applicable

### BACKGROUND OF THE INVENTION

1. Field of the Invention

The present invention relates to LED driver, and more particularly, to high efficiency multi-mode charge pump based LED driver.

2. Description of Related Art

A charge pump utilizes internal switching elements to switch at least one external capacitor, known in the art as a flying capacitor, between energy storage phase and energy transfer phase to achieve a desired output voltage. A charge pump produces an output voltage that is a multiple of its input voltage. A multiple is commonly referred to as a mode. A multiple, and therefore a mode, can be fractional. For example, a 1.5× mode charge pump means its output voltage is 1.5 times of its input voltage. The commonly found modes in today's charge pumps are 1×, 1.5×, and 2×. To maintain a high power conversion efficiency, and/or to keep the output voltage above a predetermined level, an automatic mode switching capability intrinsic to the charge pump, controlled by its input voltage change and/or output voltage change, is desirable. A charge pump with intrinsic automatic mode switching capability is called a multi-mode charge pump.

A plurality of Light Emitting Diodes, or LEDs, can be used as a backlight for a display device, for example, a Thin Film Transistor Liquid Crystal Display, or TFT LCD. The brightness level of a LED is directly related to the current flowing from the LED's Anode (positive) node to its Cathode (negative) node, commonly known in the art as forward current. A LED's forward current is determined by the voltage drop from its Anode node to its Cathode node, commonly known in the art as forward voltage. The relationship between a LED's forward current and its forward voltage can be nonlinear, and depends upon the materials the LED is made from, as well as the particular manufacturing processes on which the LED is produced.

In a backlight for a display device that uses a plurality of LEDs in close proximity, the plurality of LEDs need to operate in well matched brightness levels to ensure the backlight uniformity. Because a LED's brightness level is directly related to its forward current, the plurality of LEDs need to have well matched forward currents, providing that the LEDs are produced from same materials on same manufacturing processes. A LED driver can achieve this by having a plurality of independently controlled current sources or sinks to produce forward currents for the plurality of LEDs.

A charge pump can be used as the voltage source to provide the forward voltage to the plurality of LEDs, and to maximize the power conversion efficiency, an unregulated multi-mode charge pump is desirable. A LED driver can be used as the current source to produce the forward currents for the plurality of LEDs, and to regulate and match the forward currents of the plurality of LEDs, a LED driver with independently controlled current sources or sinks is desirable. The brightness level of the plurality of LEDs is adjusted by an external control input, such as a serial input, a PWM input, or an analog voltage input.

### BRIEF SUMMARY OF THE INVENTION

The present invention relates to LED driver, and more particularly, to high efficiency multi-mode charge pump based LED driver. It provides an exemplary embodiment of a complete and practical high efficiency multi-mode charge pump based LED driver design, as illustrated in a set of circuit diagrams in FIGS. 1-3. The charge pump based LED driver comprises a multi-mode charge pump and a LED driver circuit. It is powered by an external DC voltage source, such as a battery, and provides regulated and well matched forward currents to at least one group of a plurality of LEDs.

The multi-mode charge pump is capable of automatic switching among at least three different operation modes: a 1× bypass mode, a 1.5× boost mode, and 2× boost mode. It produces an unregulated forward voltage to at least one group of a plurality of LEDs. The charge pump comprises a switching control circuit and a switching circuit. The switching control circuit determines the desirable operation mode of the charge pump. The switching circuit comprises a plurality of switching elements and two external charge storage and transfer capacitors, commonly known in the art as flying capacitors. The switching elements of the switching circuit are selectively actuated under the directions of the switch control circuit to allow no fewer than three different operation modes. At least some of the switching elements of the switching circuit change configurations when the phase changes to charge and discharge the external flying capacitors to provide a forward voltage to at least one group of a plurality of LEDs.

The LED driver supplies the forward currents to at least one group of a plurality of LEDs. The LED driver comprises a LED brightness level control logic, and at least one LED forward current generation and regulation circuit. The LED brightness level control logic takes an external control input, which can be a 1-wire or 2-wire serial signal, a PWM signal, or an analog signal, and produces at least one internal LED brightness level control signal to control the LED forward current generation and regulation circuit. The LED forward current generation and regulation circuit in turn generates, regulates, and adjusts the forward currents of at least one group of a plurality of LEDs, and matches the forward currents to guarantee that the LEDs operate in well matched brightness levels.

### BRIEF DESCRIPTION OF THE DRAWINGS

FIG. 1a is a block diagram of a first alternative embodiment of a high efficiency multi-mode charge pump based LED driver of present invention.

FIG. 1b is a block diagram of a second alternative embodiment of a high efficiency multi-mode charge pump based LED driver of present invention.

FIG. 1c is a block diagram of a third alternative embodiment of a high efficiency multi-mode charge pump based LED driver of present invention.

FIG. 2 is a circuit schematic diagram of one embodiment of a multi-mode charge pump of the high efficiency multi-mode charge pump based LED driver of FIG. 1a-c.

FIG. 3 is a circuit schematic diagram of one embodiment of a LED driver of the high efficiency multi-mode charge pump based LED driver of FIG. 1a-c.

### DETAILED DESCRIPTION OF THE INVENTION

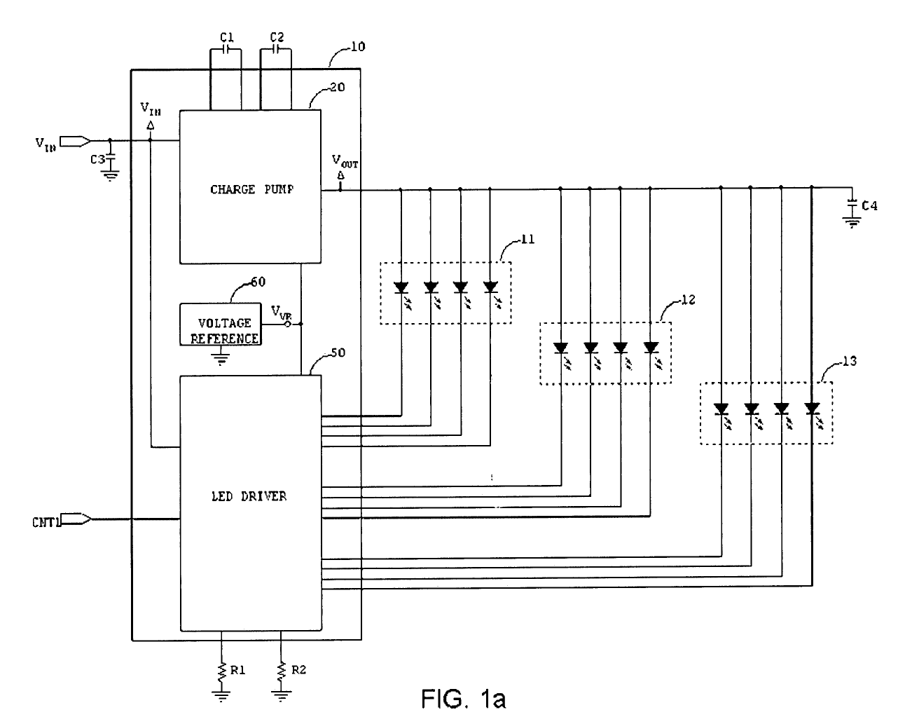

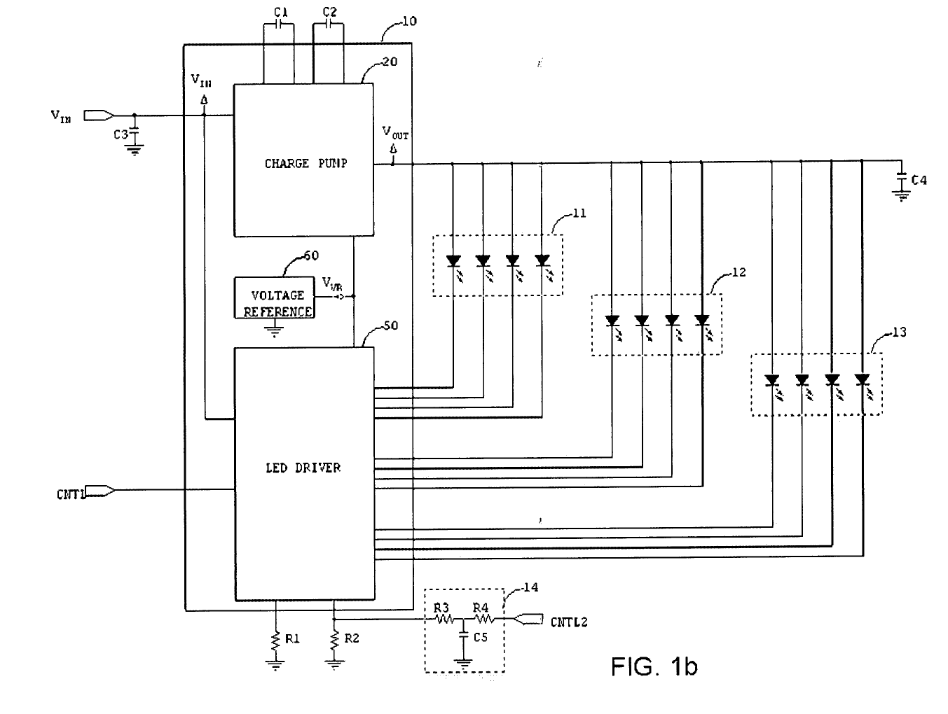

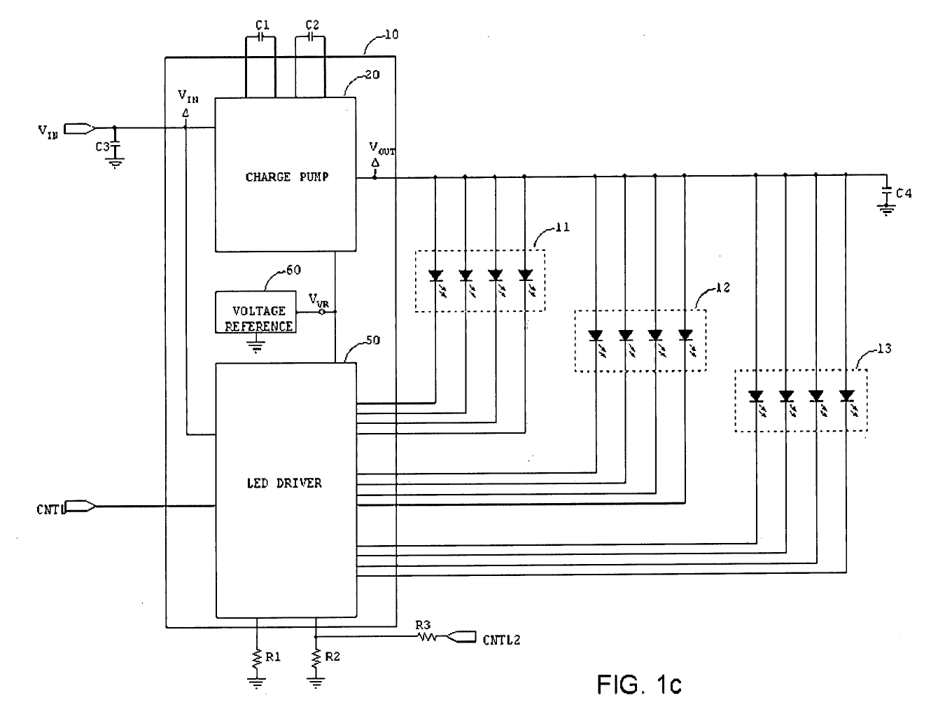

In FIG. 1a, a first alternative of an exemplary embodiment of a high efficiency multi-mode charge pump based LED driver 10 comprises a multi-mode charge pump core 20, a LED driver circuit 50, and a voltage reference 60, commonly known in the art as a bandgap voltage reference with an output voltage of V_{VR}. Charge pump based LED driver 10 is powered by an external DC voltage source V_{IN}, such as a battery, and drives three LED groups, denoted by numerals 11, 12, and 13, each comprising a plurality of LEDs.

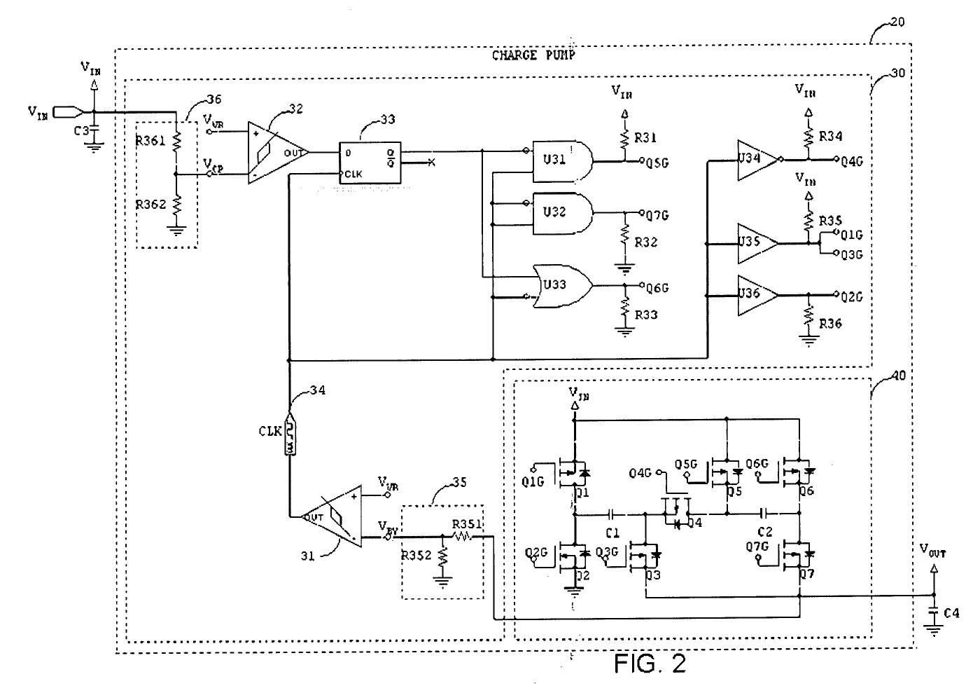

An exemplary embodiment of multi-mode charge pump 20, illustrated in FIG. 2, is capable of automatic switching among at least three different operation modes: a 1× bypass mode, a 1.5× boost mode, and 2× boost mode. Charge pump 20 is powered by DC voltage source V_{IN}, and produces an interim output voltage, V_{OUT}, to provide forward voltage to the plurality of LEDs in LED groups 11, 12, and 13. Charge pump 20 comprises a switching control circuit 30 and a switching circuit 40, as well as two external energy storage and transfer capacitors C1 and C2, commonly known in the art as flying capacitors.

Switching control circuit 30 comprises two comparators 31 and 32 with hysteresis feature, a latching device 33 commonly known in the art as D flip flops, a gated clock source 34, two voltage dividers 35 and 36, and logic gates U31-U36 with their switching control signal outputs Q1G-Q7G either pulled up to V_{IN} or pulled down to ground by resistors R31-R36. Switching circuit 40 comprises switching elements Q1-Q7 and two external charge storage and transfer capacitors C1 and C2. Switching elements Q1-Q7 are actuated under the directions of switch control signals Q1G-Q7G, respectively.

The mode in which charge pump 20 operates immediately after start up is the 1× bypass mode. During the start up period, gated clock source 34, latching device 33, and logic gates U31-U36 of switching control circuit 30 are initially disabled, and switching control signals Q1G-Q7G are generated by pull up or pull down resistors R31-R36, respectively. Switching elements Q1-Q5 of switching circuit 40 are actuated to open, or OFF, state under the directions of switch control signals Q1G-Q5G, respectively. Switching elements 06 and 07 of switching circuit 40 are actuated to close, or ON, under the directions of switching control signals Q6G and Q7G, respectively. Under such switching element configuration, the input voltage to charge pump 20, V_{IN}, is passed directly through switching elements Q6 and Q7 to the output of charge pump 20, V_{OUT}.

After the start up period, the output of charge pump 20, V_{OUT}, is established, and charge pump 20 enters the normal operation period. During this period, comparators 31 and 32 compare the output voltage from voltage reference 60, V_{VR}, and the output voltages from voltage dividers 35 and 36, V_{BY} and V_{CP}, respectively. The results of the comparisons determine the operation mode for charge pump 20 at any given time during normal operation.

In switching control circuit 30 depicted in FIG. 2, first voltage divider 35 comprises two resistors R351 and R352 in series between the output of charge pump 20, V_{OUT}, and ground, and outputs a voltage level denoted as V_{BY}. The following formula gives the value of V_{BY}:
V_{BY}=V_{OUT}×R352/(R351+R352)

V_{BY} is a DC voltage that goes to the inverting input of comparator 31. The output of voltage reference 60, V_{VR}, goes to the non-inverting input of comparator 31. The result of the comparison between V_{BY} and V_{VR}, performed by the comparator 31, determines whether charge pump 20 operated in the 1× bypass mode, or a boost mode, either 1.5× or 2×, as follow:
1) If V_{BY}>V_{VR}, the condition indicates a high V_{OUT} with reference to a predetermined threshold voltage, and a 1× bypass mode is desirable to maximize efficiency.
2) If V_{BY}<V_{VR}, the condition indicates that V_{OUT} has dropped below a predetermined threshold, and a 1.5× or 2× boost mode is desirable.

If V_{BY}>V_{VR}, a 1× bypass mode is desirable. Under this condition, comparator 31 generates a logic low output to disable gated clock source 34, which in turn disables latching device 33 and logic gates U31-U36. As a result, switching control signals Q1G-Q7G are generated by pull up or pull down resistors R31-R36, respectively. Switching elements Q1-Q5 of switching circuit 40 are actuated to open, or OFF, state under the directions of switch control signals Q1G-Q5G, respectively. Switching elements Q6 and Q7 are actuated to close, or ON, under the directions of switching control signals Q6G and Q7G, respectively. Under such switching element configuration, the input voltage to charge pump 20, V_{IN}, is passed directly through switching elements Q6 and Q7 to the output of charge pump 20, V_{OUT}.

If V_{BY}<V_{VR}, a 1.5× or a 2× boost mode is desirable. Under this condition, comparator 31 generates a logic high output to enable gated clock source 34, which in turn enables latching device 33 and logic gates U31-U36. The particular boost mode in which charge pump 20 operates, either a 1.5× mode or a 2× mode, is further selected by second voltage divider 36 comprising resistors R361 and R362 between VIN and ground. The output of second voltage divider 36, V_{CP}, is given by the following formula:
V_{CP}=V_{IN}×R362/(R361+R362)

V_{CP} is a DC voltage that goes to the inverting input of comparator 32. The output of voltage reference 60, V_{VR}, goes to the non-inverting input of comparator 32. The result of the comparison between V_{CP} and V_{VR}, performed by comparator 32, determines whether charge pump 20 operates in a 1.5× mode or a 2× mode as follow:
1) If V_{CP}>V_{VR}, the condition indicates a high V_{IN} with reference to a predetermined threshold voltage, and a 1.5× mode is desirable to maximize efficiency.
2) If V_{CP}<V_{VR}, the condition indicates that V_{IN} has dropped below a predetermined threshold voltage, and a 2× mode is desirable.

Comparator 32 outputs a logic low if a 1.5× mode is desirable, and a logic high if a 2× mode is desirable. The output goes to the D input of latching device 33. Latching device 33 and gated clock source 34 control the outputs of logic gates U31-U36, switching control signals Q1G-Q7G. Switching elements Q1-Q7 are selectively actuated under the directions of the switch control signals Q1G-Q7G. At least some of the switching elements Q1-Q7 change configurations when the phase changes between charge and discharge, in order to produce an interim voltage, V_{OUT}, at the output of switching circuit 40, to provide forward voltage to the plurality of LEDs in LED groups 11, 12, and 13. TABLE 1 below shows the logic levels of switching control signals Q1G-Q7G during each of the three modes.

TABLE 1

| Mode | Phase | CLK | Q1G | Q2G | Q3G | Q4G | Q5G | Q6G | Q7G |
|---|---|---|---|---|---|---|---|---|---|
| 1× | Bypass | — | H | L | H | H | H | L | L |
| 1× | Bypass | — | H | L | H | H | H | L | L |
| 1.5× | Charg- | H | H | H | H | L | H | L | H |
| | ing | | | | | | | | |
| 1.5× | Trans- | L | L | L | L | H | L | H | L |
| | fer | | | | | | | | |
| 2× | Charg- | H | H | H | H | L | L | H | L |
| | ing | | | | | | | | |
| 2× | Trans- | L | L | L | L | H | L | H | L |
| | fer | | | | | | | | |

TABLE 2 below shows the configurations of the switching elements Q1-Q7 during each of the three modes.

TABLE 2

| Mode | Phase | Q1 | Q2 | Q3 | Q4 | Q5 | Q6 | Q7 |
|---|---|---|---|---|---|---|---|---|
| 1× | Bypass | OFF | OFF | OFF | OFF | OFF | ON | ON |
| 1× | Bypass | OFF | OFF | OFF | OFF | OFF | ON | ON |
| 1.5× | Charging | OFF | ON | OFF | ON | OFF | ON | OFF |
| 1.5× | Transfer | ON | OFF | ON | OFF | ON | OFF | ON |
| 2× | Charging | OFF | ON | OFF | ON | ON | OFF | ON |
| 2× | Transfer | ON | OFF | ON | OFF | ON | OFF | ON |

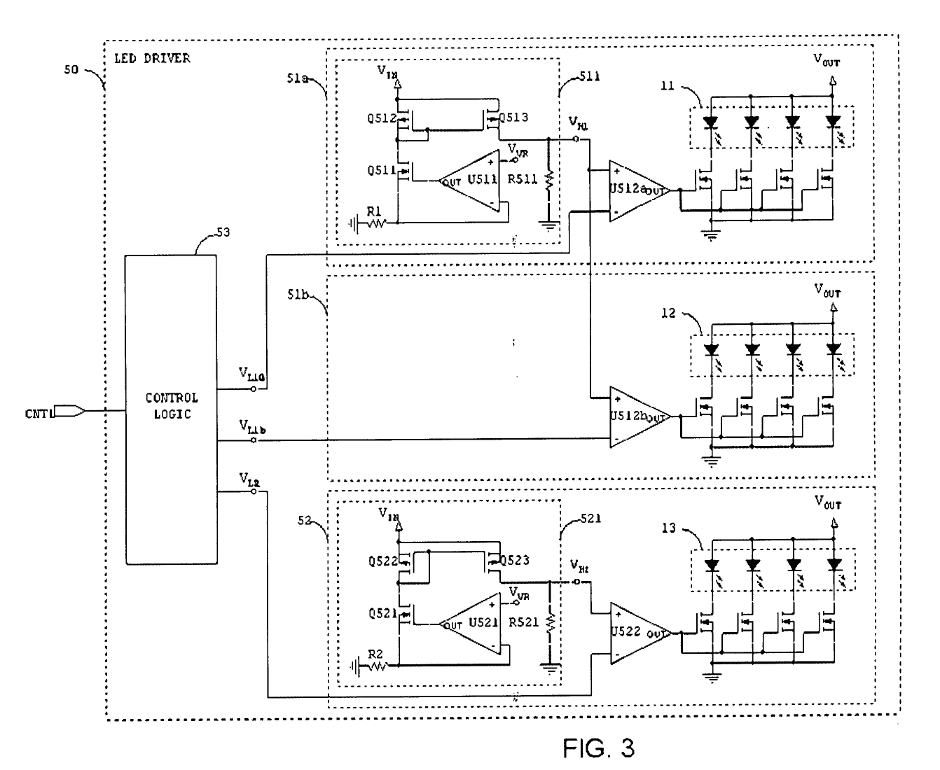

An exemplary embodiment of LED driver 50, illustrated in FIG. 3, comprises a LED brightness level control logic 53, a first LED forward current generation and regulation circuit 51a to provide forward currents to the plurality of LEDs in LED group 11, a second LED forward current generation and regulation circuit 51b to provide forward currents to the plurality of LEDs in LED group 12, and a third LED forward current generation and regulation circuit 52 to provide forward currents to the plurality of LEDs in LED group 13. LED brightness level control logic 53 processes at least one external LED brightness level control input, CNTL, which can be a serial (either 1 wire or 2 wires), a PWM, or an analog input, and outputs three control analog voltage signals V_{L1a}, V_{L1b}, and V_{L2}, to LED forward current generation and regulation circuits 51a, 51 b, and 52.

First LED forward current generation and regulation circuit 51a provides regulated forward currents to the plurality of LEDs in LED group 11. Since the plurality of LEDs in LED group 11 are used as a single backlight for a first display device in close proximity, it is desirable that they operate in well matched brightness levels to ensure the backlight uniformity. Because a LED's brightness level is directly controlled by its forward current, it is desirable that all the plurality of LEDs in LED group 11 have the same forward currents, providing that these LEDs are produced from some materials on same manufacturing processes.

Generation of a regulated forward current for each LED in LED group 11 is done by first LED forward current generation and regulation circuit 51, illustrated in FIG. 3. Transistors Q511, Q512, and Q513, an internal resistor R511, an error amplifier U511, and an external resistor R1 constitute a current source 511. The input to the non-inverting pin error amplifier U511 is the output of voltage reference 60, V_{VR}. Since there is no active signal driving the inverting pin of error amplifier U511, the voltage on its inverting pin is equal to the voltage on its non-inverting pin, V_{VR}. The current flowing through external resistor R1 to ground, 11, therefore, is given by the following formula:
I1=V_{VR}/R1

I1 serves as the reference current for a current mirror comprising transistors Q511, Q512, and Q513, which flows from V_{IN} through Q511 and Q512 to external resistor R1. A mirrored current, I511, is produced on Q513 that flows from V_{IN} to internal resistor R511. The value of I511 is proportional to I1. I511 causes a voltage drop, V_{H1}, across resistor R511. The value of V_{H1} is given by the following formula:
V_{H1}=R511×I511=M×I1=M×(V_{VR}/R1),
where M is a constant is a function of the current gain of current mirror comprising Q511, Q512, and Q513, and the value of internal resistor R511.

Error amplifier U512a takes V_{H1} as its non-inverting input, and LED brightness level control signal, V_{L1a}, produced by LED brightness level control logic 53, as its inverting input. It amplifies the voltage differential between V_{H1} and V_{L1a}, and outputs a control signal to drive the gates of a plurality of transistors, which in turn provide forward currents to the plurality of LEDs in LED group 11. The reason of having only one error amplifier U512a to drive the plurality of transistors is that, since all the transistors are produced on the same semiconductor chip, they all have identical electrical characteristics, and with the same gate voltage, they all produce the same drain to source currents as. The drain to source current of each transistor provides and is equal to the forward current to the LED it drives. Since the forward current of a LED controls its brightness level directly, having a single error amplifier U512a drive the plurality of transistors ensures that the plurality of LEDs in LED group 11 have well matched brightness levels. The forward current of each LED in LED group 11 is given by the following formula:
I_{LED1a}=N×(V_{H1}−V_{L1a})=N×(M×(V_{VR}/R1)−V_{L1a}),
where N is a function of the gain of error amplifier U512a and the gain of the transistor that drives this particular LED, and is a constant.

Second LED forward current generation and regulation circuit 51b provides regulated forward currents to the plurality of LEDs in LED groups 12 that are used as a single backlight for a second display device. The plurality of LEDs in LED group 12 are of the same materials and produced from the same manufacturing processes as the plurality of LEDs in LED group 11, therefore, each LED in LED group 12 produces the same brightness level on the same forward current as each LED in LED group 11. Typically, it is desirable that each LED in LED group 12 have the same brightness range as each LED in LED group 11. A convenient way to achieve this is to have the plurality of LEDs in LED group 12 use the same current source 511 with the plurality of LEDs in LED group 11. Error amplifier U512b takes V_{H1} as its non-inverting input, and LED brightness level control signal, V_{L1b}, as its inverting input. It amplifies the voltage differential between V_{H1} and V_{L1b}, and outputs a control signal to drive a plurality of transistors, which in turn provide forward currents to the plurality of LEDs in LED group 12. The forward current of each LED in LED group 12 is given by the following formula:
I_{LED1b}=N×(V_{H1}−V_{L1b})=N×(M×(V_{VR}/R1)−V_{L1b}),
where N is a function of the gain of error amplifier U512b and the gain of the transistor that drives this particular LED, and is a constant.

Third LED forward current generation and regulation circuit 52 provides regulated forward currents to the plurality of LEDs in LED group 13. Structures and operations of third LED forward current generation and regulation circuit 52 are identical to that of first LED forward current generation and regulation circuit 51a. Since the plurality of LEDs in LED group 13 does not necessarily need to generate the same brightness level and range as the plurality of LEDs in LED group 11 or LED group 12, the LEDs in LED group 13 are not necessarily produced from the same materials and manufacturing processes as LEDs in LED groups 11 and 12. Hence, it is desirable for third LED forward current generation and regulation circuit 52 to have its own current source 521, with an external resistor R2 to produce its own reference current, 12, with a value of V_{VR}/R2. The forward current of each LED in LED group 13 is given by the following formula:
I_{LED2}=N×(V_{H2}−V_{L2})=N×(M×(V_{VR}/R2)−V_{L2}),
where N is a function of the gain of error amplifier U522 and the gain of the transistor that drives this particular LED, and is a constant; and M is a function of the current gain of the current mirror comprising Q521, Q522, and Q523, and the value of internal resistor R521, and is a constant.

The present invention is flexible in terms of alternative means of controlling the brightness levels of the plurality of LEDs in LED groups 11, 12, and 13. For example, since LED group 13 is controlled independently from LED groups 11 and 12, it can be controlled by an input other than CNTL. Two alternative exemplary embodiments of charge pump based LED driver 10 illustrating alternative means of controlling brightness levels of the plurality of LEDs in LED group 11, 12, and 13 are shown in FIG. 1b and FIG. 1c. In these alternative embodiments, there are two control inputs: CNTL and CNTL2. CNTL is, again, an external LED brightness level control input that can be a serial signal, a PWM signal, or an analog signal, to LED brightness level control logic 53, which outputs three analog voltages V_{L1a}, V_{L1b}, and V_{L2}, to control the brightness levels of the plurality of LEDs in LED groups 11, 12, and 13, respectively. However, in these alternative embodiments, V_{L2} that controls the brightness levels of the plurality of LEDs in LED groups 13 is set to a predetermined constant value and is independent of external LED brightness level control input, CNTL. The brightness levels of the plurality of LEDs in LED groups 13 are a function of the predetermined constant value of V_{L2}, and a second control input signal, CNTL2.

In second alternative exemplary embodiment of charge pump controlled LED driver 10 illustrated by FIG. 1b, CNTL2 is a PWM input that goes through a external filter 14, which comprises resistors R3 and R4, and a capacitor C5. Filter 14 converts PWM input CNTL2 into an analog voltage, whose value is directly controlled by the duty cycle, or duty ratio, of PWM input CNTL2. This analog voltage is connected to external resistor R2, and produces a current, I_{PWM}, flowing through R2 to the ground, in addition to reference current 12 discussed in previous paragraphs. As a result, the overall current flowing through external resistor R2 is now I2+I_{PWM}, which becomes the new reference current for current source 521 of LED forward current generation and regulation circuit 52 in FIG. 3. Now the forward current of each LED in LED group 13 is given by the following formula:
I_{LED2}=N×(M×(V_{VR}/R2+I_{PWM})−V_{L2}),
where I_{PWM} is a function of the duty ratio of control input CNTL2, and V_{L2} is a predetermined constant

In the second alternative exemplary embodiment of charge pump controlled LED driver 10 illustrated by FIG. 1c, CNTL2 is an analog input connected to external resistor R2 through an external resistors R3, and produces a current, I_{ANA}, flowing through R2 to the ground, in addition to reference current I2 discussed in previous paragraphs. As a result, the overall current flowing through external resistor R2 is now I2+I_{ANA}, which becomes the new reference current for current source 521 of LED forward current generation and regulation circuit 52 in FIG. 3. Now the forward current of each LED in LED group 13 is given by the following formula:
I_{LED2}=N×(M×(V_{VR}/R2+I_{ANA})−V_{L2},
where I_{ANA} is a function of the value of CNTL2, and V_{L2} is a predetermined constant

I claim:

1. A high efficiency multi-mode charge pump based LED driver, comprising:
a) an input voltage, connected to a voltage source;
b) at least one LED brightness level control input;
c) a multi-mode charge pump;
d) a LED driver;
e) a voltage reference, with a constant output voltage; and
f) an output voltage, connected to at least one group of a plurality of LEDs.

2. The high efficiency multi-mode charge pump based LED driver of claim 1, wherein at least some elements constituting said high efficiency multi-mode charge pump based LED driver, are implemented in a single semiconductor chip.

3. The high efficiency multi-mode charge pump based LED driver of claim 1, wherein said multi-mode charge pump comprises a switching control circuit and a switching circuit, is powered by said input voltage, and produces said output voltage.

4. The high efficiency multi-mode charge pump based LED driver of claim 3, wherein said switching control circuit comprises:
a) a first voltage divider comprising two resistors between said output voltage and ground;
b) a second voltage divider comprising two resistors between said input voltage and ground;
c) a first comparator with hysteresis feature;
d) a second comparator with hysteresis feature;
e) a latching device;
f) a gated clock source; and
g) a plurality of logic gates, with pull-up or pull-down resistors connected to their outputs.

5. The high efficiency multi-mode charge pump based LED driver of claim 4, wherein said first comparator with hysteresis feature of said switching control circuit compares output voltage from said first voltage divider of said switching control circuit and constant output voltage from said voltage reference to select the operation mode for said multi-mode charge pump between a bypass mode and a boost mode.

6. The high efficiency multi-mode charge pump based LED driver of claim 4, wherein said second comparator with hysteresis feature of said switching control circuit compares output voltage from said second voltage divider of said switching control circuit and constant output voltage from said voltage reference to select the operation mode for said multi-mode charge pump between at least two different boost modes.

7. The high efficiency multi-mode charge pump based LED driver of claim 4, wherein said latching device, said gated clock source, and said plurality of logic gates of said switching control circuit produce switching control signals to control said switching circuit.

8. The high efficiency multi-mode charge pump based LED driver of claim 3, wherein said switching circuit comprises a plurality of switching elements that switch at least one external capacitor.

9. The high efficiency multi-mode charge pump based LED driver of claim 8, wherein said switching circuit processes switching control signals produced by said switching control circuit, actuates some or all of said plurality of switching elements to select from and switch between a bypass mode and at least two different boost modes, with each boost mode comprising at least two different phases, to produce said output voltage connected to at least one group of a plurality of LEDs.

10. The high efficiency multi-mode charge pump based LED driver of claim 1, wherein said LED driver comprises a LED brightness control logic circuit and at least one LED forward current generation and regulation circuit, is powered by said input voltage and controlled by said at least one LED brightness level control input, and produces forward currents to at least one group of a plurality of LEDs.

11. The high efficiency multi-mode charge pump based LED driver of claim 10, wherein said LED brightness control circuit of said LED driver takes at least one external LED brightness level control input, which can be a 1-wire or 2-wire serial signal, or a PWM signal, or an analog voltage signal, and outputs at least one LED forward current control signal to said at least one LED forward current generation and regulation circuit of said LED driver.

12. The high efficiency multi-mode charge pump based LED driver of claim 10, wherein said at least one LED forward current generation and regulation circuit of said LED driver comprises:
a) a current source;
b) an error amplifier; and
c) a plurality of transistors, connected to at least one group of a plurality of LEDs.

13. The high efficiency multi-mode charge pump based LED driver of claim 12, wherein said current source of said at least one LED forward current generation and regulation circuit comprises:
a) an error amplifier, comprising three transistors;
b) an external resistor;
c) a current mirror; and
d) an internal resistor.

14. The high efficiency multi-mode charge pump based LED driver of claim 13, wherein said error amplifier of said current source uses the constant voltage output of said voltage reference to produce a current on said external resistor of said current source; the current is used as the reference current for said current mirror of said current source, which in turn produces a current to cause a voltage drop across said internal resistor of said current source.

15. The high efficiency multi-mode charge pump based LED driver of claim 12, wherein said error amplifier of said at least one LED forward current generation and regulation circuit compares a voltage produced by said current source of said at least one LED forward current generation and regulation circuit, and the constant output voltage produced by said voltage reference, to produce an output voltage to drive the gates of said plurality of transistors of said at least one LED forward current generation and regulation circuit to provide forward currents to at least one group of a plurality of LEDs.
